(19) United States
(12) Patent Application Publication
(10) Pub. No.: US 2008/0049972 A1
(43) Pub. Date: Feb. 28, 2008

(54) Mail imaging system with secondary illumination/imaging window

(75) Inventors: Wayne M. Blackwell, Chenango Forks, NY (US); Mark D. Goodwin, Apalachin, NY (US); Glenn L. Kehley, Endicott, NY (US); Mathew S. Hale, Barton, NY (US)

Correspondence Address: Lockheed Martin Corporation;c/o WOLF, GREENFIELD & SACKS, P.C., 600 ATLANTIC AVENUE, BOSTON, MA, 02210-2206, US

(73) Assignee: Lockheed Martin Corporation, Bethesda, MD (US)

(21) Appl. No.: 11/824,825

(22) Filed: Jul. 3, 2007

Related U.S. Application Data
(60) Provisional application No. 60/819,217, filed on Jul. 7, 2006.

(51) Int. Cl. G06K 9/00

(52) U.S. Cl. 382/101

(57) ABSTRACT

An imaging and illumination system for use with a mail processing apparatus may include illumination and imaging assemblies located in a housing that has first and second windows to transmit imaging illumination for the illumination assembly and/or the imaging assembly. The first and second windows may be arranged to interact with mailpieces that are moved along a path relative to the first and second windows. The direction of travel for the mailpieces may be parallel to the first plane and transverse to the second plane, and the second window may be arranged downstream of the first window. Thus, the first and second windows may be arranged at an angle with respect to each other, and the second window may be arranged at an angle with respect to the direction of travel of mailpieces past the second window.

This application claims the benefit of U.S. Provisional Application No. 60/819,217, filed Jul. 7, 2006, which is hereby incorporated by reference in its entirety.

### FIELD OF INVENTION

This invention relates generally to imaging assemblies, and more particularly to an imaging assembly that controls imaging illumination based on object location and/or other conditions external to the imaging assembly.

### BACKGROUND OF INVENTION

Imaging systems have been implemented in numerous industrial and commercial settings, such as on high-speed mail sorting systems. In one implementation, a line scan camera may be fixed in a stationary position and mail items may be conveyed within the camera's field of view via a conveyor. As the mail items enter the field of view, they may be imaged by the camera, e.g., using a CCD imaging device. Image data captured by the camera may be analyzed (e.g., for determining if the mail has suitable postage, for determining the destination address for the mail, etc.) or otherwise processed.

Often, line scan cameras are implemented on mail sorting systems as part of a camera assembly. For example, many line scan cameras reside in a housing which protects the camera's components from the operating environment, e.g., external dust, dirt, humidity, etc. The camera assembly may, for example, define a window which provides the camera with a field of view toward mail items on the conveyor path. In addition, because many line scan cameras require a mail item to be illuminated with relatively bright light to capture an accurate image, the camera assembly may include lighting components, such as fluorescent, halogen or sodium vapor lamps, or light emitting diodes (LEDs) to illuminate an item to be imaged. Further, many camera assemblies include components to cool the assembly, since lighting and/or image capture components may produce sufficient heat to reduce the useful life of other components inside the housing.

### SUMMARY OF INVENTION

In one aspect of the invention, an imaging and illumination system for use with a mail processing apparatus includes an illumination assembly including at least one illumination source, and an imaging assembly constructed and arranged to capture image information from one or more mailpieces that are illuminated by the illumination assembly. The illumination and imaging assemblies may be located in a housing that has first and second windows to transmit imaging illumination for the illumination assembly and/or the imaging assembly for a mailpiece. The first and second windows may each have first and second planes, respectively, and be arranged to interact with mailpieces that are moved along a path in a downstream direction relative to the first and second windows. The downstream direction may be parallel to the first plane and transverse to the second plane, and the second window may be arranged downstream of the first window. Thus, the first and second windows may be arranged at an angle with respect to each other, and the second window may be arranged at an angle with respect to the direction of travel of mailpieces past the second window. This arrangement may help isolate (lightwise) the windows from each other, and/or help resist mailpieces from engaging the second window.

In another aspect of the invention, a method for imaging in a mail processing apparatus includes providing an imaging system housing with a first window to transmit imaging illumination for a mailpiece adjacent the first window, and a second window to transmit imaging illumination for a mailpiece adjacent the second window. The first and second windows may each have first and second planes, respectively, that lie in the window and that are transverse to each other. A mailpiece may be moved along a linear path in a downstream direction relative to the first and second windows, and the second window may be arranged downstream of the first window. Illumination may be provided from at least one illumination source and be transmitted through the first and/or second window, and image information may be captured from one or more mailpieces based on illumination transmitted through the first and/or second window.

In another aspect of the invention, a system for imaging in a mail processing apparatus includes housing means with a first window to transmit imaging illumination for a mailpiece adjacent the first window, and a second window to transmit imaging illumination for a mailpiece adjacent the second window. The first and second windows may each have first and second planes, respectively, that lie in the window and that are transverse to each other. Moving means may move a mailpiece along a linear path in a downstream direction relative to the first and second windows, and illumination means may provide illumination that is transmitted through the first and/or second window. Image capture means may capture image information from one or more mailpieces based on illumination transmitted through the first and/or second window.

These and other aspects of the invention will be apparent from the following description and claims.

### BRIEF DESCRIPTION OF THE DRAWINGS

Aspects of the invention are described below with reference to illustrative embodiments, wherein like numerals reference like elements, and wherein:

FIG. 1 is a perspective view of an imaging illumination system in a mail processing system in accordance with aspects of the invention; and

FIG. 2 is a top schematic view of the imaging illumination system of FIG. 1.

### DETAILED DESCRIPTION

It should be understood that aspects of the invention are described herein with reference to the figures, which show illustrative embodiments in accordance with aspects of the invention. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

In one aspect of the invention, an imaging illumination system for use in a mail processing system includes a housing that contains an imaging illumination source, such as an ultraviolet (UV) illumination source, and an imaging device, which may include a CCD device with associated optical lenses or other components, one or more phototransistors, or any other light sensitive device suitable for capturing image information. The housing may serve to protect the illumination source, imaging device and other components from environmental conditions outside of the housing, such as dirt, dust, humidity, extreme temperatures, and so on. The housing may have two windows, for example, each forming a rectangular slit-like opening, through which imaging illumination may exit the housing to illuminate a mailpiece located near the window. Illumination from the mailpiece (whether reflected, fluorescent, phosphorescent or otherwise emanating from the mailpiece) may pass through the windows in the housing for detection by the imaging device. As a result, the imaging illumination system may capture image information of mailpieces located near the housing for use in routing the mailpieces or other processing.

For example, the system may emit visible light through a first window to illuminate a mailpiece near the first window. Light from the mailpiece may be detected by a first imaging device, such as a camera including a CCD device, to capture image information for the mailpiece. The system may also emit UV illumination through a second window in the housing to illuminate the mailpiece. The mailpiece may include special ink or other markings that fluoresce and/or phosphoresce visible light when illuminated with UV light. For example, some meter marks or other indicia formed on mailpieces emit a reddish light when exposed to UV light. As another example, some barcodes formed on mailpieces emit an orange light when exposed to UV light. As another example, postage stamps affixed to mailpieces may emit a green light when exposed to UV light. The fluorescent, phosphorescent or other light from the mailpiece indicia may be captured by a second imaging device, such as an array of photodetectors, to capture image information for the mailpiece.

In one aspect of the invention, the mailpieces may be moved along a linear path in a downstream direction, e.g., by a conveyor, relative to the imaging illumination system housing. The first window may be arranged in a first plane that is parallel to the linear path, and in one embodiment, the first window may include a transparent member that actually contacts the mailpiece as it moves past the housing. The second window may be arranged in a second plane downstream of the first window, and may be arranged so that the second plane is at an angle relative to the downstream direction and relative to the first window. Having the windows arranged in this way in some embodiments may provide advantages such as allowing for lightwise isolation of the windows from each other, allowing for more accurate registration of image information captured by the first and second imaging devices, reducing the likelihood that a mailpiece will catch on the second window, and reducing contact of mailpieces with the housing.

Isolating the first and second windows from each other may be important to help ensure that illumination at one window does not affect the results at another window. For example, the second imaging device may be used to capture image information based on visible light that is emitted from the mailpiece in response to exposure to UV light. Thus, it may be desired to only illuminate the imaged portion of the mailpiece using UV light, and not visible light. If the first and second windows are not properly isolated, visible light used for imaging at the first window may “leak” over toward the second window and contribute to image information that is captured by the second imaging device.

Accurate registration of image information captured by the first and second imaging devices can be important if image analysis depends at least in part on correlating images from the two devices. For example, in one embodiment, it may be desired to first identify the location of a meter mark, and then perform a more detailed analysis of the mark, e.g., using an optical character recognition, pattern matching or other analysis. As mentioned above, the meter mark may be printed in a particular ink that fluoresces in response to UV light. Thus, the image information from the second imaging device may be used to identify portions of the mailpiece that include a UV responsive marking. Thereafter, secondary image analysis may be performed on the image information captured by the first imaging device. However, the secondary analysis may only be performed on those portions of the image data that correspond to the location(s) identified on the mailpiece that were identified as likely to include a meter mark. Thus, the secondary image analysis may be targeted to specific portions of the image data, potentially saving time and computer resources.

Reducing the likelihood that a mailpiece will catch on a window and/or reducing contact between mailpieces and the imaging illumination system housing may be important to help reduce damage to mailpieces during processing, help reduce delays in processing due to conveyor jams or other stoppage and/or to help reduce damage to any transparent member located at the second window. For example, the first window may be arranged to make contact with mailpieces, and as a result, may need a special purpose material, such as a sapphire material, that is suitably hard to resist scratching and abrasion. Regardless, however, longterm contact with mail may damage the window material such that an adverse affect on image capture results. By locating the second window at an angle to the movement direction of the mail, contact with the window may be reduced or eliminated, thereby eliminating the need for special purpose window materials.

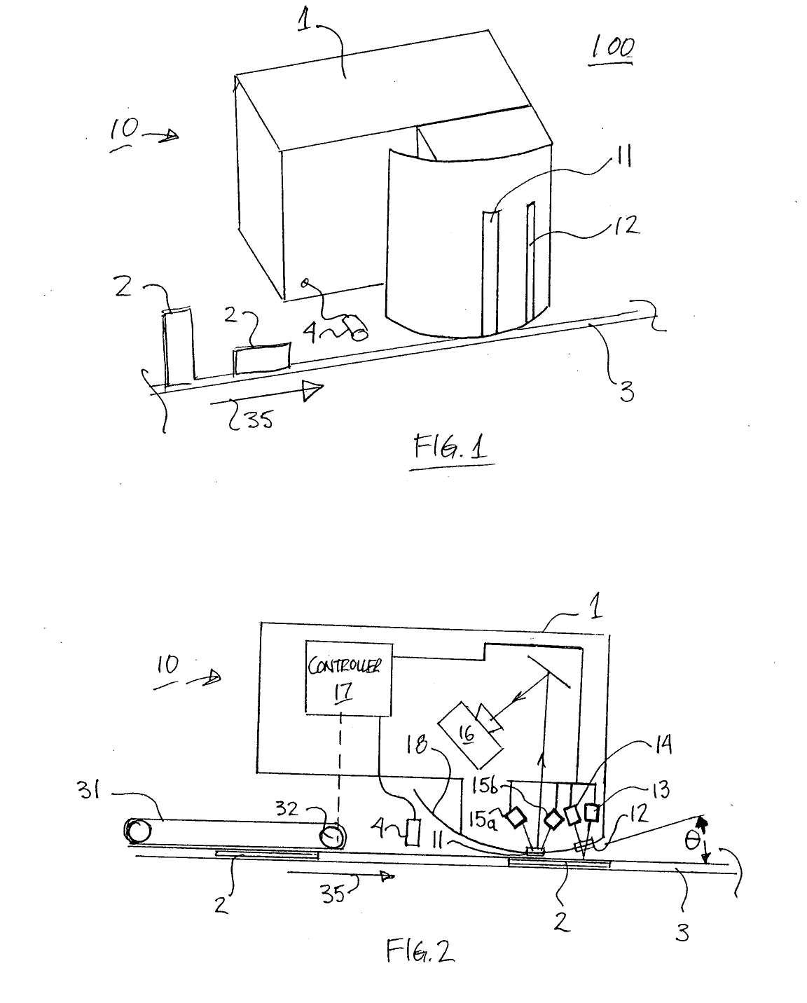

FIG. 1 shows a perspective schematic view of a mail processing system 100 having an imaging illumination system 10 for illuminating and imaging mailpieces 2 that are moved along path in a downstream direction (see arrow 35) by a conveyor 3. In this illustrative embodiment, the imaging illumination system 10 includes a housing 1 with first and second windows 11 and 12 used to transmit illumination for imaging mailpieces 2 as they travel with the conveyor 3. The windows 11 and 12 may include a transparent member, such as a sapphire plate, that covers each window and helps prevent dust, dirt or other contaminants from entering the housing 1. In one embodiment, the windows 11 and 12 may include a semi-transparent member, such as an optical filter, to alter the properties of the illumination or of the returned image, that may also cover each window and helps to prevent dust, dirt or other contaminants from entering the housing 1. The transparent member may also be arranged to make contact with mailpieces 2 as they pass the window, e.g., the conveyor 3 may press mailpieces against the window 11 when adjacent to the window 11. As discussed above, the first window 11 may be arranged to make contact with mailpieces 2 as they pass by the window, e.g., to ensure that the imaged portion of the mailpiece is suitably located in or near the imaging system's focal plane. However, the second window 12 may be located downstream of the first window 11 and at a suitable angle to the direction of travel of the mailpieces 2 such that the second window 12 in general does not contact mailpieces 2. This arrangement may reduce the frictional load placed on mailpieces 2 (and therefore the conveyor 3) as well as reduce wear on the second window 12 and the mailpieces 2.

The first and second windows 11 and 12 may be used in any suitable way for illuminating and/or imaging mailpieces 2. For example, in this illustrative embodiment, mailpieces 2 are illuminated by a visible light source and imaged by a first imaging device at the first window 11, and are illuminated by a UV light source and imaged by a second imaging device at a second window 12. However, it should be understood that mailpieces may be illuminated at one window and imaged at another window, illuminated by devices external to the housing 1 and imaged by devices within the housing 1 via the first and/or second windows 11 and 12, illuminated by devices within the housing 1 via the first and/or second windows 11 and 12 and imaged by devices external to the housing, etc. Also, although in this embodiment the first window 11 is arranged to contact mailpieces and the second window 12 does not typically make contact with mailpieces, both windows may be arranged to make contact (or not) with mailpieces 2 in some embodiments. In short, the windows 11 and 12 may be arranged in any suitable way, in accordance with aspects of the invention.

The imaging illumination system 10 in this embodiment also includes a mailpiece presence sensor 4 that detects the presence of mailpieces 2 as they move near the housing 1 along the conveyor 3. Typically, mailpieces 2 will have some space between them on the conveyor 3, e.g., as shown in FIG. 1. Thus, there will be periods when there is no mailpiece 2 located at the window 11 or 12 whether for illumination or imaging purposes. During these periods, one or more illumination sources in the imaging illumination system 10 need not emit illumination. By disabling the illumination source(s), the life of the illumination source(s) may be extended, and emission of unused illumination may be avoided.

FIG. 2 shows a top schematic diagram of the imaging illumination system 10. In this illustrative embodiment, the housing 1 encloses a visible light source 15 and a UV illumination source 13, which each respectively produce illumination to illuminate a mailpiece 2 located adjacent the first and second windows 11 and 12. Illumination from the visible light source 15 that is reflected from the mailpiece 2 adjacent the first window 11 may be received by a first imaging device 16 and used to capture image information for the mailpiece 2. Similarly, illumination from the UV illumination source 13 may cause light to be emitted from the mailpiece 2 and through the second window 12 for detection by a second imaging device 14.

As can be seen in FIG. 2, the first window 11 may be formed in the nose wear plate 18 and arranged in a first plane that is parallel to the direction along which mailpieces are moved past the first window 11. The second window 12 may be formed in a portion of the nose wear plate 18 that is downstream of the first window 11, and be arranged in a second plane that is transverse to the first plane. In one embodiment, the angle θ between the first and second planes may be between about 5-10 degrees, but may be arranged at other angles. The nose wear plate 18 may be curved as shown to help guide mailpieces appropriately and to help reduce contact with the mailpieces 2. In one embodiment, the mailpieces 2 may contact the imaging illumination system 10 only at the first window 11, with portions upstream and downstream of the first window 11 generally not contacting the mailpieces. As a result, the second window 12 may include a transparent member to help keep dust, dirt and other contaminants out of the housing 1, but that need not be arranged for contact with mailpieces, e.g., need not have a relatively high hardness and/or abrasion resistance. Also, arranging the first and second windows 11 and 12 at an angle relative to each other may help lightwise isolate the windows with respect to each other, e.g., since the second window 12 faces generally away from the first window 11, illumination emitted at the first window 11 is less likely to interfere with imaging at the second window 12, and vice versa.

In this illustrative embodiment, the first and second windows 11 and 12 have a generally rectangular shape being about 6.5 inches high and about 0.5 inches wide. However, the windows 11 and 12 may be arranged to have other sizes and shapes. For example, the second window 12 may be arranged to have discrete openings (e.g., having a circular shape) for each photodetector in the second imaging device 14. The second window 12 may also be arranged to have guide bars or other elements that span across the second window 12 generally in the direction of mailpiece travel. The guide bars may aid in guiding mailpieces past the second window 12 and help reduce unwanted catching or other engagement of mailpieces with the second window 12.

The visible light source 15 and UV illumination source 13 may include any suitable components for producing desired light to illuminate a mailpiece 2. For example, in this illustrative embodiment, the visible light source 15 may include one or more light emitting devices (LEDs) arranged to emit light from the first window 11. Any suitable number of LEDs may be used, and the LEDs may emit light of the same or different wavelengths. Also, any other suitable optical devices may be included in the visible light source 15, such as diffusers, lenses, homogenizers, diffraction devices, filters, or any other suitable device to operate on the light emitted by the LEDs in any suitable way. In this illustrative embodiment, the visible light source 15 includes two elements 15a and 15b on either side of the first window 11 that emit light at an angle relative to the downstream direction of the mailpieces 2 at the first window 11. Each element 15a and 15b includes three vertical columns of 58 LEDs that extend along the length of the first window 11. Each column of LEDs has a repeating pattern of two white light emitting LEDs followed by one aqua light emitting LED. The elements 15a and 15b also each include a diffuser to homogenize the light emitted by the LEDs, e.g., to more uniformly illuminate the mailpieces 2 at the first window 11.

The UV illumination source 13 in this illustrative embodiment includes a vertical column of UV light emitting LEDs, e.g., having 26 total LEDs. Within the housing 1, the windows 11 and 12 and the light sources 14 and 15 are isolated from each other, e.g., so that UV light is not emitted through the first window 11, and visible light is not emitted through the second window 12. It should be understood that the visible light source 15 and the UV illumination source 13 may be arranged in any suitable way. For example, the UV illumination source 13 may include a UV tube, instead of LEDs and may include any other suitable optical elements (such as diffusers, lenses, filters, etc.) like the visible light source 15. Likewise, the visible light source 15 may include any suitable light emitting devices, such as one or more lamps or other.

The first and second imaging devices 16 and 13 may include any suitable components, such as a CCD imaging device, one or more phototransistors or other photodetectors, and/or any other suitable image sensing device. In this illustrative embodiment, the first imaging device 16 includes a CCD device along with suitable optical components, such as lenses, stops, focal length adjustment components, and others. Although not shown, this embodiment preferably includes at least one mirror to fold the optical axis of the first imaging device 16 to thereby make the space required for the first imaging device 16, and thus the housing 1, more compact. The second imaging device 14 in this embodiment includes a linear array of 26 phototransistors, e.g., arranged in a column that extends along the length of the second window 12. The second imaging device 14 may also include a filter that passes only selected wavelengths of visible light, and otherwise blocks UV light. Thus, in this embodiment, the second imaging device 14 may detect visible light that is emitted from a mailpiece in response to being illuminated by UV light. As is known in the art, such an arrangement can allow for detection of meter and other markings on mail made with ink or other material that fluoresces (in this case emits visible light) in response to UV illumination. One potential advantage of using a small number of phototransistors is a short optical path that fits near the mailpiece, minimizing space requirements. The first and second imaging devices 16 and 13 may capture image information having any desired resolution. For example, in the case of the second imaging device 14, the phototransistors may be arranged to detect illumination from an area on a mailpiece such that each pixel in the image information corresponds to approximately a ¼ inch square area on the mailpiece 2. Such resolution may be suitable for finding the location of particular UV sensitive marks on mailpieces, such as meter marks, fluorescent barcodes and others. The first imaging device 16 may have significantly higher resolution, e.g., suitable for use in optical character recognition and other pattern recognition analyses.

Components of the imaging illumination system 10 may operate under the control of a controller 17, which may include any suitable components for performing desired signal input/output, and other functions. The controller 17 and/or higher level controller may include any suitable general purpose data processing system, which can be, or include, a suitably programmed general purpose computer, or network of general purpose computers, and other associated devices, including communication devices, and/or other circuitry or components necessary to perform the desired input/output or other functions. The controllers can also be implemented at least in part as single special purpose integrated circuits (e.g., ASICs), or an array of ASICs, each having a main or central processor section for overall, system-level control and separate sections dedicated to performing various different specific computations, functions and other processes under the control of the central processor section. The controller 17 can also be implemented using a plurality of separate dedicated programmable integrated or other electronic circuits or devices, e.g., hardwired electronic or logic circuits, such as discrete element circuits or programmable logic devices. The controller 17 may communicate with portions of the system 10 in any suitable way, such as by wired and/or wireless link, and in any suitable format and/or communications protocol. The controller may also include other devices, such as an information display device, user input devices, such as a keyboard, user pointing device, touch screen or other user interface, data storage devices, communication devices or other electronic circuitry or components.

As discussed above, the imaging illumination system 10 may include a mailpiece presence sensor 4 that detects each mailpiece on the conveyor 3 as the mailpiece approaches the housing 1. The sensor 4 may communicate with the controller 17 so that the controller 17 may control the other portions of the system 10 based on the mailpiece detection. For example, the controller 17 may receive information from an encoder 32 or other suitable sensor regarding the speed of a belt 31 of the conveyor 3. Based on this information, the controller 17 may know the speed at which mailpieces 2 are traveling on the conveyor 3 and therefore determine when a mailpiece detected by the presence sensor 4 will be adjacent the first and/or second windows 11 and 12. Thus, the controller 17 may control the visible light source 15, the UV illumination source 13, and the first and second imaging devices 16 and 13 to operate when the mailpiece is suitably located relative to the first and second windows 11 and 12. In this illustrative embodiment, a UV illumination source interrupt may include the controller 17 and the presence sensor 4 (and optionally the encoder 32, if provided), and may control the UV illumination source 13 to emit light only when the mailpiece is located at the second window 12. Otherwise, when no mailpiece 2 is located at the second window 12, the UV illumination source 13 may be disabled.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An imaging and illumination system for use with a mail processing apparatus, comprising:
an illumination assembly including at least one illumination source;
an imaging assembly constructed and arranged to capture image information from one or more mailpieces that are illuminated by the illumination assembly; and
a housing with a first window to transmit imaging illumination for the illumination assembly and/or the imaging assembly for a mailpiece, and a second window to transmit imaging illumination for the illumination assembly and/or the imaging assembly for a mailpiece, the first and second windows each having first and second planes, respectively;
wherein the first and second windows are arranged to interact with mailpieces that are moved along a linear path in a downstream direction relative to the first and second windows, the downstream direction being parallel to the first plane and transverse to the second plane, and the second window being arranged downstream of the first window.

2. The system of claim 1, wherein the first window includes an elongated rectangular opening with a long dimension arranged perpendicular to the downstream direction.

3. The system of claim 1, wherein the second window includes an elongated rectangular opening with a long dimension arranged perpendicular to the downstream direction.

4. The system of claim 1, wherein the first window is used to transmit illumination from the at least one illumination source to a mailpiece and to transmit illumination from the mailpiece to the imaging assembly; and the second window is used to transmit illumination from the at least one illumination source to a mailpiece and to transmit illumination from the mailpiece to the imaging assembly.

5. The system of claim 4, wherein the at least one illumination source includes first and second illumination sources and the imaging assembly includes first and second imaging devices, and wherein the first illumination source and the first imaging device are used with the first window, and the second illumination source and the second imaging device are used with the second window.

6. The system of claim 1, wherein the first and second windows are lightwise isolated from each other.

7. The system of claim 1, wherein the first and second planes are arranged at an angle of approximately 5 to 10 degrees relative to each other.

8. The system of claim 1, wherein the first window includes a transparent member arranged to resist entry of material into the housing through the first window and arranged to contact mailpieces moved near the first window, and wherein the second window includes a transparent member arranged to resist entry of material into the housing and arranged to generally avoid contact with mailpieces moved near the second window.

9. The system of claim 1, wherein the housing includes a nose wear plate member arranged to make contact with mailpieces moved in the downstream direction and including the first and second windows, the nose wear plate member including a portion downstream of the first window that is curved away from the downstream direction and that includes the second window.

10. A method for imaging in a mail processing apparatus, comprising:
providing an imaging system housing with a first window to transmit imaging illumination for a mailpiece adjacent the first window, and a second window to transmit imaging illumination for a mailpiece adjacent the second window, the first and second windows each having first and second planes, respectively, that lie in the window and are transverse to each other;
moving a mailpiece along a linear path in a downstream direction relative to the first and second windows, the second window being arranged downstream of the first window;
providing illumination from at least one illumination source that is transmitted through the first and/or second window; and
capturing image information from one or more mailpieces based on illumination transmitted through the first and/or second window.

11. The method of claim 10, wherein the first window includes an elongated rectangular opening with a long dimension arranged perpendicular to the downstream direction.

12. The method of claim 10, wherein the second window includes an elongated rectangular opening with a long dimension arranged perpendicular to the downstream direction.

13. The method of claim 12, wherein the step of providing illumination comprises:
transmitting illumination from the at least one illumination source through the first window to a mailpiece; and
transmitting illumination from the at least one illumination source through the second window to a mailpiece; and wherein the step of capturing image information comprises:
transmitting illumination from the mailpiece through the first window to the imaging assembly; and
transmitting illumination from the mailpiece to the imaging assembly.

14. The method of claim 13, wherein the at least one illumination source includes first and second illumination sources and the imaging assembly includes first and second imaging devices, and wherein the first illumination source and the first imaging device are used with the first window, and the second illumination source and the second imaging device are used with the second window.

15. The method of claim 10, wherein the first and second windows are lightwise isolated from each other.

16. The method of claim 10, wherein the first and second planes are arranged at an angle of approximately 5-10 degrees relative to each other.

17. The method of claim 10, wherein the first window includes a transparent member arranged to resist entry of material into the housing through the first window and arranged to contact mailpieces moved near the first window, and wherein the second window includes a transparent member arranged to resist entry of material into the housing and arranged to generally avoid contact with mailpieces moved near the second window.

18. The method of claim 10, wherein the housing includes a nose wear plate member arranged to make contact with mailpieces moved in the downstream direction and including the first and second windows, the nose wear member including a portion downstream of the first window that is curved away from the downstream direction and that includes the second window.

19. A system for imaging in a mail processing apparatus, comprising:
housing means with a first window to transmit imaging illumination for a mailpiece adjacent the first window, and a second window to transmit imaging illumination for a mailpiece adjacent the second window, the first and second windows each having first and second planes, respectively, that lie in the window and are transverse to each other;
moving means for moving a mailpiece along a linear path in a downstream direction relative to the first and second windows, the second window being arranged downstream of the first window;
illumination means for providing illumination from at least one illumination source that is transmitted through the first and/or second window; and
image capture means for capturing image information from one or more mailpieces based on illumination transmitted through the first and/or second window.
